(19) United States
(12) Patent Application Publication
(10) Pub. No.: US 2016/0252000 A1
(43) Pub. Date: Sep. 1, 2016

(54) DUAL MODE COOLING PUMP WITH OVER-RUNNING CLUTCH

(71) Applicant: BorgWarner Inc., Auburn Hills, MI (US)

(72) Inventor: David M. VanZuilen, Fremont, IN (US)

(21) Appl. No.: 14/634,802

(22) Filed: Feb. 28, 2015

(51) Int. Cl. F01P 5/12; F04D 29/22; F04D 29/041; F16D 41/00; F04D 29/42; F04D 29/52; F04D 25/06; F01P 3/20; F04D 29/18; F04D 29/043

(52) U.S. Cl. CPC F01P 5/12; F04D 29/181; F04D 29/22; F04D 29/041; F04D 29/043; F04D 29/426; F04D 29/528; F04D 25/068; F01P 3/20; F16D 41/00

(57) ABSTRACT

System for circulating the flow of coolant in a vehicle engine cooling system. A dual mode mechanism has an electric motor and an overrunning clutch mechanism which selectively rotate an impeller at a desired speed to circulate the coolant. The impeller is rotated by the electric motor, but can also be selectively rotated by the overrunning clutch mechanism. An electronic control can be utilized to selectively control the electric motor and overrunning clutch, together with control logic.

### TECHNICAL FIELD

The present invention is related to systems for controlling the flow of coolant in a vehicle, particularly utilizing a coolant pump which has both electrical and mechanical modes of operation.

### BACKGROUND OF THE INVENTION

The great majority of vehicles today utilize engines run on an organic fuel, such as gasoline. Due to the heat developed by the engines during use, various cooling systems have been developed for maintaining the temperature of the engine within acceptable limits. These cooling systems typically circulate a coolant fluid through the engine, radiator and other components in order to extract heat from the engine.

The need today for vehicles to meet higher gas mileage standards and also meet stricter standards on toxic emissions has resulted in the development of various assemblies, components and engine systems which have attempted to meet these standards. At the same time, as vehicles get smaller to reduce weight and the number of components is added to the engines, the demand for smaller and lighter components and packaging has increased.

Some of the products utilized to circulate the engine coolant are coolant pumps. These include those with electromagnetic, viscous and mechanical drives. Similarly, cooling fans are utilized to reduce the temperature of the engine coolant, and these also can have electromagnetic, viscous and mechanical drives. These accessory products are also being supplied today and are subject to the same limitations as to size, number of components and cost.

Electric accessory products which include electric motors and are run by electricity are more common today. Similarly, hybrid accessory products which include an electric mode of operation and a mechanical mode are also known today. These accessory products are subject to similar limitations of size, components and cost.

There is a need today for coolant pumps and cooling fan accessories which have advantages in size and cost and still maintain the performance of known accessories, or which have even superior performance.

### SUMMARY OF THE INVENTION

The present invention meets these needs and provides a two mode accessory product, namely a coolant pump, which is an improvement over known coolant pumps. The invention increases the effectiveness of the engine cooling system, helps increase fuel mileage, has lower cost, reduces undesirable emissions and provides an overall package size and shape that can be positioned at more locations in an engine compartment.

A preferred embodiment of the invention includes a dual mode device for operating an impeller which circulates the coolant in the cooling system. The preferred embodiment of the invention involves an electric motor to provide electrical operation of the coolant pump and an overrunning clutch to provide mechanical operation of the coolant pump. The electric motor is the primary source to rotate the coolant impeller, and the overrunning clutch can be engaged to operate the impeller at input speed when necessary.

Other features, benefits and advantages of the invention will become apparent from the following brief description of the drawings, the drawings themselves, the detailed description of the preferred embodiments and the appended claims.

### BRIEF DESCRIPTION OF THE DRAWINGS

FIG. 1 is a perspective view of an embodiment of the invention.

FIG. 2 is a cross-sectional view of the embodiment of the invention depicted in FIG. 1.

FIG. 3 is an enlarged view of area “3” in FIG. 2.

FIG. 4 is a perspective view of an overrunning clutch which can be utilized in the embodiment of the invention shown in FIG. 1.

FIGS. 5 and 7 depict the modes of use of the overrunning clutch embodiment which can be utilized with an embodiment of the invention.

FIG. 6 is a cross-section through line 6-6 in FIG. 5.

FIG. 8 is a schematic diagram of a control system for use with the preferred embodiment of the invention.

FIG. 9 is a chart depicting examples of use of the invention.

### DESCRIPTION OF PREFERRED EMBODIMENTS

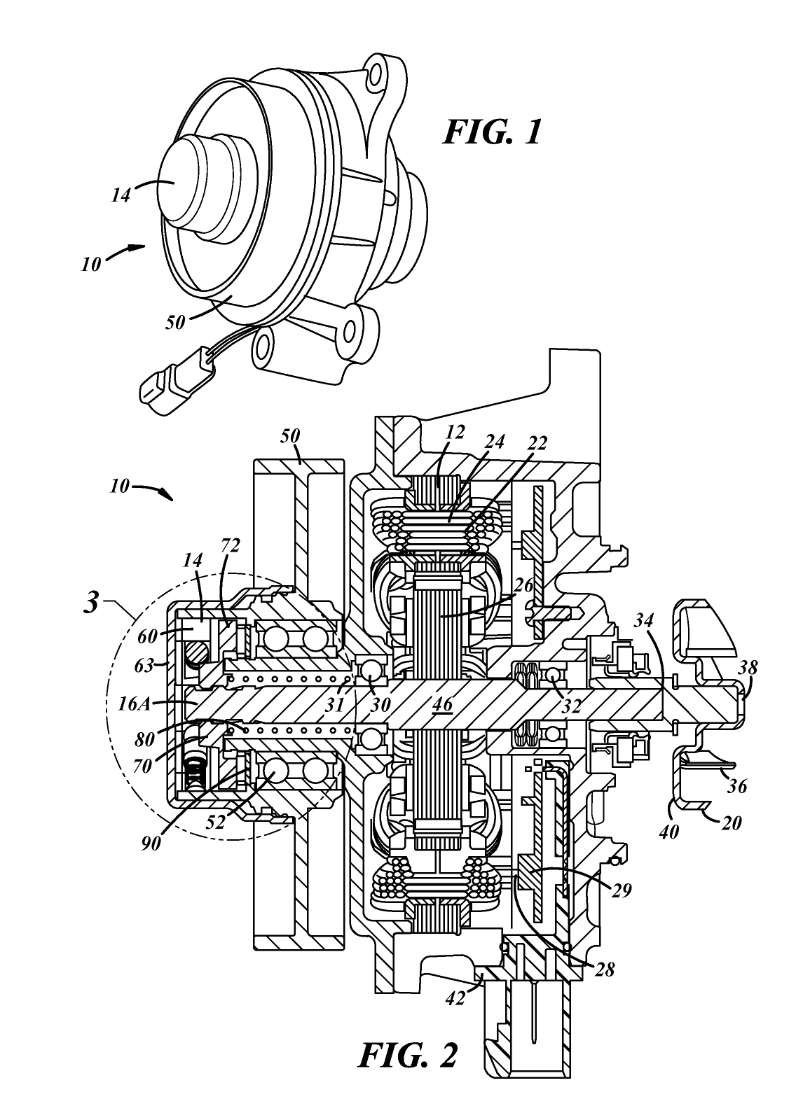

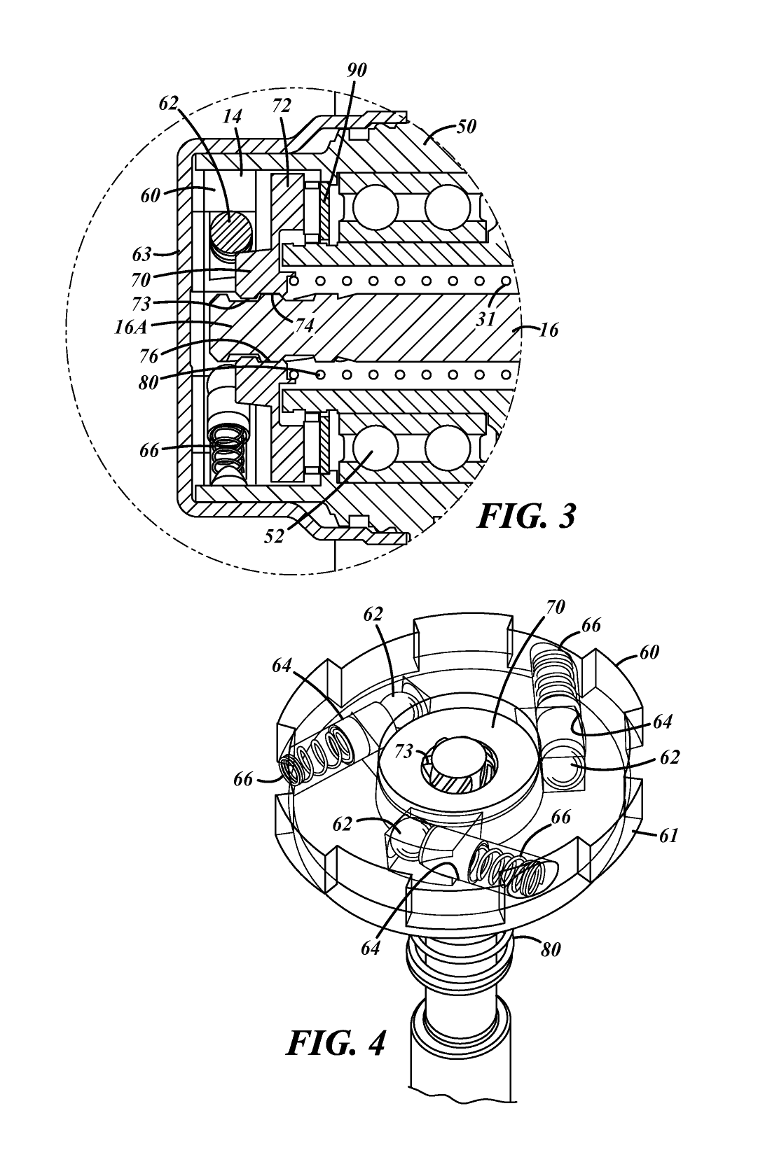

As shown in FIGS. 1-3, a preferred dual mode embodiment of the invention 10 includes an electric mechanism motor 12, an overrunning clutch mechanism 14, a central shaft member 16 and an impeller member 20. The dual mode coolant pump including an electric motor and overrunning clutch and has two separate modes of operation, namely electrical and mechanical.

The electric motor mechanism 12 includes an electric motor 22, which preferably is a brushless DC motor. The mechanism 12 includes a stator 24, a rotor 26, and is actuated electronically through wire lead 28 and electronic circuit board 29. The rotor 26 is directly connected to the shaft member 16 and, when energized, rotates the shaft member and impeller 20 at a desired speed. The rotational speed is determined by an electric control unit (ECU) of the engine or vehicle which receives inputs from a variety of sensors. (Representative ECU 25 and sensors 27 are depicted in FIG. 8.) The sensors read numerous operating conditions, such as coolant temperature, and transmits those conditions to the engine ECU or a coolant pump ECU or both. The appropriate energy is then provided to the motor to rotate the impeller when necessary and at an appropriate speed to keep the temperature of the coolant within desired limits. A control system of this type is shown schematically in FIG. 6. The dual mode mechanism also can have a separate ECU which communicates with the main ECU of the engine.

The electric motor is positioned in housing member 42. The shaft member 16 is rotatably supported in the motor mechanism by a pair of bushing members 30 and 32. The impeller member 20 is attached to the shaft member by a mounting mechanism 34. The impeller has a plurality of curved blades 36 attached to a central hub member 38. The hub and blade members are positioned in an outer shroud member 40.

When it is necessary to rotate the impeller member at a greater speed in order to increase the coolant flow, for example, when the engine is being used to drive a heavy load or the vehicle is proceeding up a steep incline, the electric motor is deactivated (deenergized) and the shaft member 16 and impeller member 20 are then driven directly by the overrunning clutch at input speed.

The clutch member 14 is engaged by the pulley member 50 for this purpose. Normally the pulley member 50, which is rotating at input speed from the engine, spins freely around bearing member 52.

The dual mode coolant pump 10 is normally operated by the electric motor 22. The one-way clutch member 14 is only engaged and activated when additional speed of the impeller 20 is needed to cool the engine coolant and prevent the engine from overheating.

The overrunning clutch 14 is selectively attached to and operated by the pulley member 50. The clutch member 14 includes an outer race member 60 and an inner race member 70. The inner race member 70 is attached to a plunger member 72 and is adapted to be moved into and out of engagement with the outer race member 60.

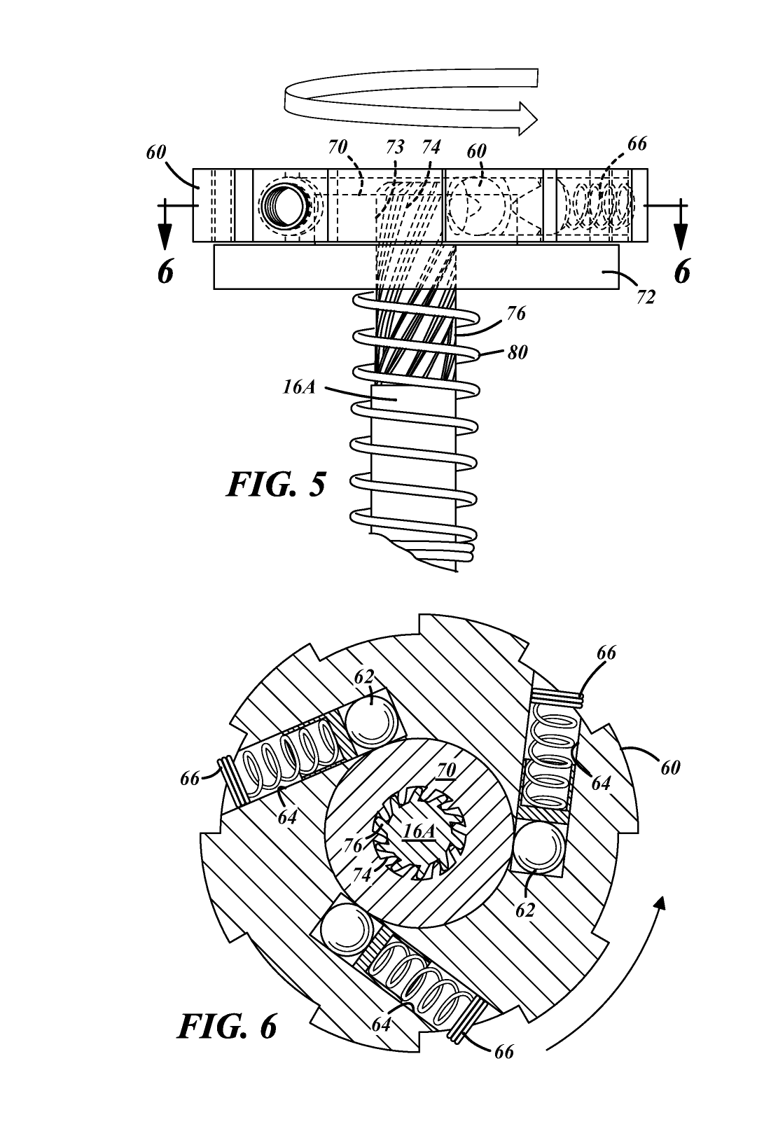

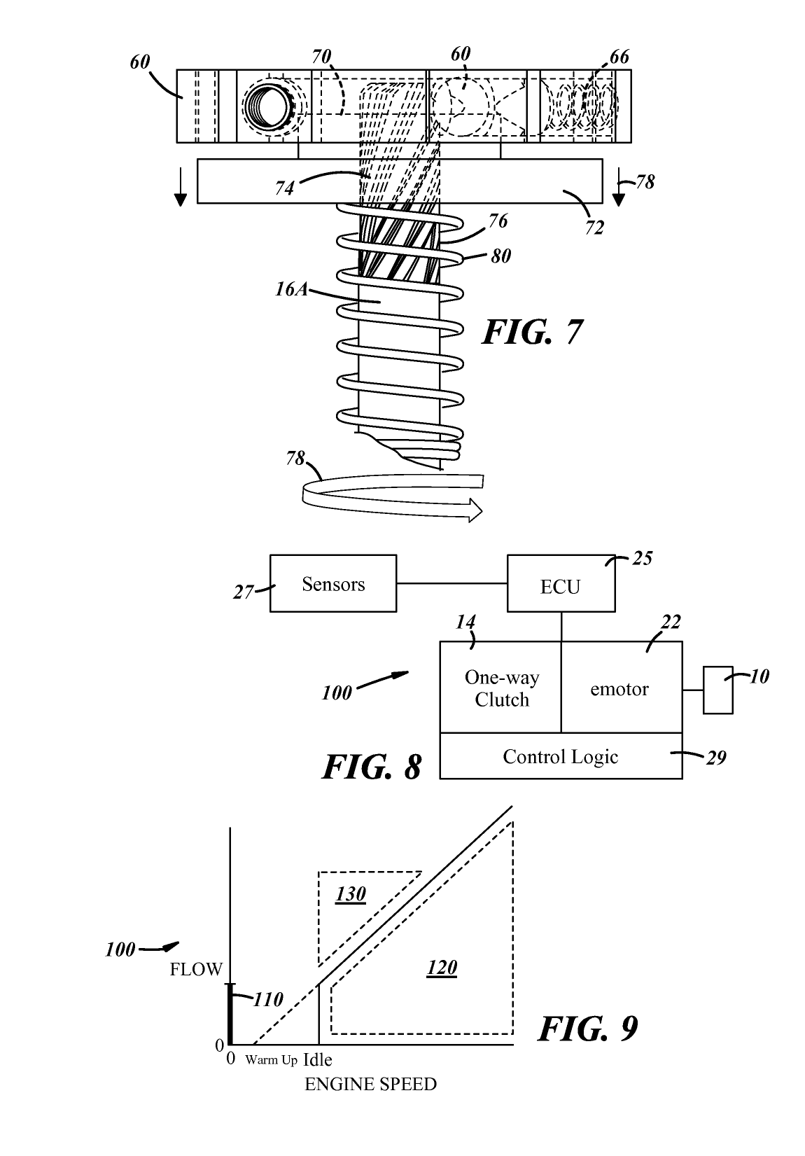

As shown in FIGS. 4-7, the outer race member has a plurality of ball bearing members 62 which are biased in channels or pockets 64 by biasing spring members 66. Although three ball bearing members 62 and three spring biasing mechanisms are shown in FIGS. 4-7, the actual number of ball bearing mechanisms can vary and depends on the size and strength of the overrunning clutch that is desired.

The plunger member 72 has a center opening 73 with a helical splined surface 74. The end 16A of the shaft member 16 has a matching helical splined outer surface 76. Thus, when the shaft member 16 rotates, it axially moves the plunger member 72, and thus the inner race member 70, into and out of engagement with the outer race member 60.

A spring member 80 positioned around the end 16A of the shaft member 16, as shown in FIG. 2, is biased between the plunger member 72 and a shoulder 31 (or bearing member 30). When the inner race 70 is disengaged from the outer race 60 by a disengagement rotation of the plunger member 72 by the shaft member 16 in the direction 78, the spring member 80 is then selectively used to force the plunger member 72 and inner race member 70 into engagement with the outer race when desired. The spring member 80 returns the plunger member 72 and thus the attached inner race member 70 axially to engagement with overrunning outer race member 60.

In order to hold the plunger member 72 and inner race member 70 in the disengaged position, a thrust bearing 90 is utilized. The lower surface of plunge member 72 makes contact with the thrust bearing member 90 when the plunger member 72 is lowered. The motor torque makes the plunger 72 move axially downwardly (away from the outer race 60) into engagement with the thrust parasitic bearing 90 to hold the plunger 72 and inner race 70 in the disengaged (declutched) position. The thrust bearing 90 provides counter torque to keep the plunger member 72 and inner race member 70 disengaged from the overrunning clutch.

The outer surface 61 of the outer race 60 is attached to the cover 63 and pulley member 50 and is continuously rotating at input speed.

Although the preferred embodiment utilizes a plunger member fixedly attached to the axially moveable inner race member of the overrunning clutch mechanism, it is also possible to provide the inner race member and plunger member as a one piece member, which is adapted in accordance with the invention to move axially along the impeller shaft and into and out of engagement with the outer race member.

In operation, the impeller shaft is rotated primarily by the electric motor. Thus the impeller rotates at output speed and circulates the engine coolant at the flow rate desired to maintain the temperature of the coolant—and thus the engine—within the appropriate temperature range. In situations where more pump speed is required than the electric motor can achieve, for example, when the vehicle is heavily loaded, going up a hill or pulling a trailer, the electric motor is turned off and the overrunning clutch is used to rotate the impeller mechanically at input speed.

When the electric motor is turned on, torque is applied to the helical spline which pulls the plunger and inner race axially downwardly disengaging the overrunning clutch. The impeller shaft and impeller are decoupled from the clutch and are driven at output speed by the electric motor. This circulates the coolant at output speed. The plunger and inner race are held at the disengaged position by coming in to contact with a thrust bearing that supplies counter torque to the plunger and inner race. This prevents the return spring from returning the inner race into contact with the outer race.

At the disengaged position, the plunger, inner race and thrust bearing (at least the upper half thereof) are rotated with the shaft member at input speed. At the same time, the outer race which is connected to the pulley, continues to rotate at input speed.

When mechanical driving of the impeller shaft is needed or desired, the electric motor is turned off. This eliminates the counter torque on the plunger and inner race and allows the spring member to force the plunger and inner race axially upwards and return the inner race into engagement with the outer race. This covers the impeller shaft and impeller to be rotated at input speed.

Since the rotor of the electric motor is connected to the impeller shaft, the rotor also rotates at input speed during the mechanical operation of the coolant pump.

As an alternate embodiment relative to changing from electric motor drive to mechanical drive, the electric motor could be briefly reversed in direction after it is stopped in order to assist the spring member in urging the plunger and inner race member toward engagement with the outer race.

As indicated above, the pulley member which is continuously operating at input speed (by an engine belt member), is connected to the cover member which in turn is connected to the outer race member of the overrunning clutch. The outer race member is thus continuously rotating at input speed. The pulley member is fixedly attached to the cover member in any conventional manner, and the cover member is fixedly attached to the outer race member in any conventional manner. It is also possible for the pulley ember to alternatively be fixedly attached directly to the outer race member.

The outer surface of the outer race member and the cover member and/or pulley member could have any conventional interlocking or interengagement mechanisms for fixedly attaching one to the other. For example, the outer race could have an outer surface configuration as shown in FIGS. 4 and 6 and the cover member could have a corresponding configuration creating an interlocking or interengagement between the two members.

A damping material or member (not shown) could also be positioned between the cover member and outer race member in order to prevent or minimize any non-smooth engagement of mechanical operation of the dual mode cooling pump. For example, materials made of rubber or an elastomer could be utilized for this purpose.

FIG. 8 schematically depicts a control system 100 for operation of embodiment 10. The control of the electric motor is operated by the ECU 25 of the vehicle. Control logic 29 is contained in the coolant pump ECU. The engine ECU receives data from various sensors 27 and communicates to the coolant pump ECU to control the speed of the impeller.

In the situation where the vehicle is turned off, that is, the engine has stopped running, it is still necessary in many instances to maintain the flow of the coolant fluid until the engine and other components cool down. In this instance, typically the coolant fan will continue to operate by power from the battery. Similarly, the ECU and control logic could continue to operate the electric motor and rotate the impeller, also by battery power. This would provide flow of the coolant in the cooling system and though the engine until the engine and other components were cooled sufficiently.

The graphic diagram 100 in FIG. 9 illustrates many of these situations. At zone 110, the vehicle engine is turned off and the coolant fluid is continuing to continuing to flow primarily by the impeller (coolant pump) through actuation of the electric motor. This could be at a constant speed.

Zone 120 of the diagram 100 is the situation where the engine is picking up speed and the coolant flow and temperature are increasing also. Zone 120 is commonly referred to as the “over-speed mode”. More coolant flow is provided by operating the impeller using the electric motor of the dual mode mechanism. In this zone, the engine RPM is not providing sufficient mechanical speed to produce the flow that the cooling system is demanding. The ECU and control logic operate the coolant pump (i.e. rotate the impeller) by the electric motor up to input speed, as needed. The RPM or speed of the impeller will increase as necessary to maintain the temperature of the coolant within the desired range.

In zone 130, the impeller is operated either electrically or mechanically as needed, depending on the impeller speed required. If the desired speed is below that of input speed, then the impeller is operated electrically by the electric motor. If input speed is needed, then the impeller is operated mechanically at input speed. Together, based on the ECU and control logic, the necessary impeller speed and coolant flow are effectuated in order to control the temperature of the coolant fluid.

Thus, as exemplified by the embodiments described above, the inventive system utilizes an electric motor and a one-way clutch mechanism, such as an overrunning clutch mechanism in order to form a dual mode cooling pump device. The electrical motor 22 preferably is a brushless DC electric motor. The electric motor 22, when activated by the ECU 25 and control logic 29, rotates the impeller 20 to cause the coolant fluid to flow through the cooling system and keep the temperature of the coolant fluid within desired limits.

The overrunning clutch 14 is positioned in operative association with the impeller shaft. Other embodiments and types of one-way clutches can be used for this purpose.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A temperature control system for a vehicle cooling system comprising:
a housing, said housing having an inlet and an outlet for ingress and egress of coolant;
an impeller positioned in the housing for circulating the coolant in the vehicle cooling system;
a dual mode device attached to said housing for rotating said impeller;
said dual mode device comprising an electric motor and an overrunning clutch, both positioned to separately and selectively rotate said impeller.

2. The temperature control system as described in claim 1 wherein said electric motor is a brushless DC motor.

3. The temperature control system as described in claim 1 wherein said impeller comprises a hub member, a plurality of blade members attached to said hub member, and a shroud member.

4. The temperature control system as described in claim 3 wherein said shroud member has at least a portion positioned radially outward of said blade members.

5. The temperature control system as described in claim 1 further comprising a coolant pump ECU and control logic, wherein said coolant pump ECU in combination with said control logic actuate the speed of rotation of said impeller.

6. A temperature control system for a vehicle cooling system comprising:
a housing;
an impeller shaft positioned in the housing;
an impeller connected to the shaft for circulating the coolant in the vehicle cooling system;
an overrunning clutch in the housing for rotating said impeller shaft;
an electric motor positioned in said housing for rotating said impeller; and
an ECU and control logic for selectively rotating said impeller by either said electric motor or said overrunning clutch.

7. The temperature control system as described in claim 6 wherein said electric motor is a brushless DC motor.

8. The temperature control system as described in claim 6 wherein said impeller comprises a hub member, a plurality of blade members attached to said hub member, and a shroud member.

9. The temperature control system as described in claim 8 wherein said shroud member has at least a portion positioned radially outward of said blade members.

10. The temperature control system as described in claim 6 wherein said ECU in combination with said control logic actuate the speed of rotation of said impeller and the engagement and disengagement of the overrunning clutch.

11. A method for regulating the temperature of cooling fluid in a vehicle engine, said method comprising the steps of:
providing an impeller activating device comprising:
a housing;
an impeller positioned in the housing for circulating the coolant in a vehicle cooling system;
a dual mode device attached to said housing for rotating said impeller;
said dual mode device comprising an electric motor and an overrunning clutch, both positioned to separately and selectively rotate said impeller; and
selectively activating or not activating said dual mode device to rotate said impeller; and
whereby the temperature of the cooling fluid is substantially maintained within a desired range of temperature.

12. The method as described in claim 11 wherein said electric motor is a brushless DC electric motor.

13. A method for regulating the temperature of cooling fluid in a vehicle engine, said method comprising the steps of:
providing an impeller activating device comprising:
a housing, said housing having an inlet and an outlet for ingress and egress of coolant;
an impeller positioned in the housing for circulating the coolant in a vehicle cooling system;
an electric motor attached to said housing for rotating said impeller;
an overrunning clutch mechanism in said housing for rotating said impeller;
an ECU and control logic for selectively rotating or not rotating said impeller by said electric motor and for selectively engaging and disengaging operation of said overrunning clutch mechanism;
selectively activating or not activating said electric motor to regulate the rotation speed of said impeller; and
selectively engaging or disengaging said overrunning clutch mechanism to regulate the flow of coolant fluid through said housing;
whereby the temperature of the cooling fluid is substantially maintained within a desired range of temperature.

14. The method as described in claim 13 wherein said electric motor is a brushless DC electric motor.

15. A dual mode coolant pump assembly comprising:
a pulley member which rotates at input speed;
an overrunning clutch mechanism having an outer race member connected to said pulley member and having an axially moveable inner race member;
a shaft member having a first end and a second end, said first end having a first set of helical splines thereon;
an impeller member attached to said second end of said shaft member;
said inner race member having an opening therein with a second set of helical splines thereon and is positioned on said first end of said shaft member;
an electric motor connected adjacent to said second end of said shaft member for rotation of said shaft member and said impeller member;
wherein coolant can be circulated for cooling a vehicle engine.

16. The dual mode coolant pump as described in claim 15 further comprising a control system for selectively operating said electric motor or said overrunning clutch mechanism in order to rotate said shaft member.

17. The dual mode coolant pump as described in claim 15 wherein said overrunning clutch mechanism is adapted to be engaged to rotate said shaft member and disengaged to not rotate said shaft member.

18. The dual mode coolant pump as described in claim 17 further comprising a thrust bearing positioned to contact said inner race member when said overrunning clutch member disengages.

19. The dual mode coolant pump as described in claim 15 wherein said electric member is a brushless DC motor with a rotor member connected to said shaft member.

20. The dual mode coolant pump as described in claim 15 wherein said inner race member comprises a plunger member fixedly attached to said inner race member, and wherein said plunger member is positioned on said first end of said shaft member.

21. The dual mode coolant pump as described in claim 20 wherein said second set of helical splines extends into said plunger member.
